(19) United States
(12) Patent Application Publication
(10) Pub. No.: US 2003/0017741 A1
(43) Pub. Date: Jan. 23, 2003

(54) Duplex cable connector collar apparatus, assembly, method of use, and method of making same

(75) Inventors: James Earl Olson, Rochester, MN (US); Dennis James Veerkamp, St. Charles, MN (US)

Correspondence Address: Steven W. Roth, IBM Corporation, Dept. 917, 3605 Highway 52 North, Rochester, MN, 55901-7829, US

(73) Assignee: INTERNATIONAL BUSINESS MACHINES CORPORATION, ARMONK, NY

(21) Appl. No.: 09/909,264

(22) Filed: Jul. 19, 2001

(51) Int. Cl. H01R 13/00

(52) U.S. Cl. 439/483

(57) ABSTRACT

An apparatus for joining connectors of two cables, e.g., optical cables, that plug into a receptacle. The connectors each have a pull member operative to release engagement of an ear member of the connector with a hook member of the receptacle to permit detachment of the connector from the receptacle. The connectors may be type MPO connectors, for example. The connectors are joined by a collar that is slid over the pull members. The collar has two apertures, each configured to receive one of the pull members. The apertures each have a projection positioned to be received in a recess on the pull members. Preferably, the collar is resilient to allow resilient deformation as the projections slide toward capture in the recesses. The connectors may be simultaneously detached from the receptacle by pulling the collar in a direction away from the receptacle.

### FIELD OF THE INVENTION

The present invention relates in general to duplex cable connectors. More particularly, the present invention relates to a duplex cable connector collar apparatus, assembly, method of use, and method of making same.

### BACKGROUND

The development of the EDVAC computer system of 1948 is often cited as the beginning of the computer era. Since that time, computer systems have evolved into extremely sophisticated devices, and computer systems may be found in many different environments. Since the dawn of the computer age, the cables have been used to transfer data between computers and input/output devices, and between computers. For example, cables are used in input/output (I/O) device attachment applications, such as disk drive, tape storage and printer attachment. Cables are also used in networking applications, such as local-area networks (LANs) and wide-area networks (WANs). An important trend in the past ten years has been the increasing use of fiber optic cables in such applications.

Cables typically include a connector at each end that is plugged into a receptacle associated with the computer and/or I/O device. Typical is a connector of the type MPO connector family that may be included at one or more ends of fiber optic cables. Such connectors, sometimes referred to as MTP connectors, are specified in ISO/IEC 1754-7, Fibre Optic Connector Interfaces—Type MPO Connector Family.

In many applications, it is necessary to connect a plurality of cables rather than a single cable. For example, one cable may be used to receive data in one direction and another cable may be used to transmit data in the other direction. In such an application, the two cables are together sometimes referred to as a duplex cable. To simplify cable management when a plurality of cables are used, it is desirable to plug the connectors thereof into the receptacle in a single mating action. Typically, this is accomplished through the use of a common housing that provides the plurality of connectors in a single molded piece. This reduces the probability of mis-configuration, but requires manufacturers and users to stock yet another type of cable.

Alternatively, a clip may serve to join individual connector housings. Such a connector system is disclosed in U.S. Pat. No. 5,876,233 to Choudhury et al., which is assigned to the same assignee as is the present invention. The clip, which is typically formed of metal or high strength plastic, includes channels or slots that permit insertion of the cables into the clip. While such a clip overcomes the problem of introducing another type of cable, it may allow the cables to fall through the channels or slots prior to being plugged into the receptacle. Thus, such a prior art clip may not effectively reduce the probability of mis-configuration.

Therefore, there exists a need to provide an enhanced duplex cable connector mechanism that effectively reduces the probability of mis-configuration without requiring the introduction of another type of cable.

### SUMMARY OF THE INVENTION

An object of the present invention is to provide an enhanced duplex cable connector mechanism that addresses these and other problems associated with the prior art.

These and other objects of the present invention are achieved by providing an enhanced duplex cable connector collar apparatus, assembly, method of use, and method of making same. The duplex cable connector collar apparatus joins connectors of two cables, e.g., optical cables, that plug into a receptacle. The connectors each have a pull member operative to release engagement of an ear member of the connector with a hook member of the receptacle to permit detachment of the connector from the receptacle. The connectors may be type MPO connectors, for example. The connectors are joined by a collar that is slid over the pull members. The collar has two apertures, each configured to receive one of the pull members. The apertures each have a projection positioned to be received in a recess on the pull members. Preferably, the collar is resilient to allow resilient deformation as the projections slide toward capture in the recesses. The connectors may be simultaneously detached from the receptacle by pulling the collar in a direction away from the receptacle. The collar effectively reduces the probability of mis-configuration, without the introduction of another type of cable. Because the projections of the collar are captured in the recesses of the connectors, the collar is more effective in retaining the connectors and reducing the probability of mis-configuration as compared to prior art clips.

### BRIEF DESCRIPTION OF THE DRAWINGS

The present invention together with the above and other objects and advantages can best be understood from the following detailed description of the embodiments of the invention illustrated in the drawings, wherein like reference numerals denote like elements.

FIG. 1 is a block diagram of a networked computer system consistent with the present invention.

FIG. 2 is a top view of a fiber optic cable having type MPO connectors consistent with the present invention.

FIG. 3 is a perspective enlarged view of one of the type MPO connectors of the fiber optic cable shown in FIG. 2.

FIG. 4 is a perspective view of a receptacle consistent with the present invention into which the type MPO connector shown in FIG. 3 may be plugged.

FIG. 5 is a perspective view of a duplex cable connector assembly according to an embodiment of the present invention.

FIG. 6 is a perspective view of a receptacle consistent with the present invention for receiving the duplex cable connector assembly shown in FIG. 5.

FIG. 7 is an elevational view of a duplex cable connector collar apparatus of the duplex cable connector assembly shown in FIG. 5.

FIG. 8 is a cross-sectional view of the duplex cable connector collar apparatus of the shown in FIG. 7.

### DETAILED DESCRIPTION OF THE PREFERRED EMBODIMENTS

### Hardware Environment

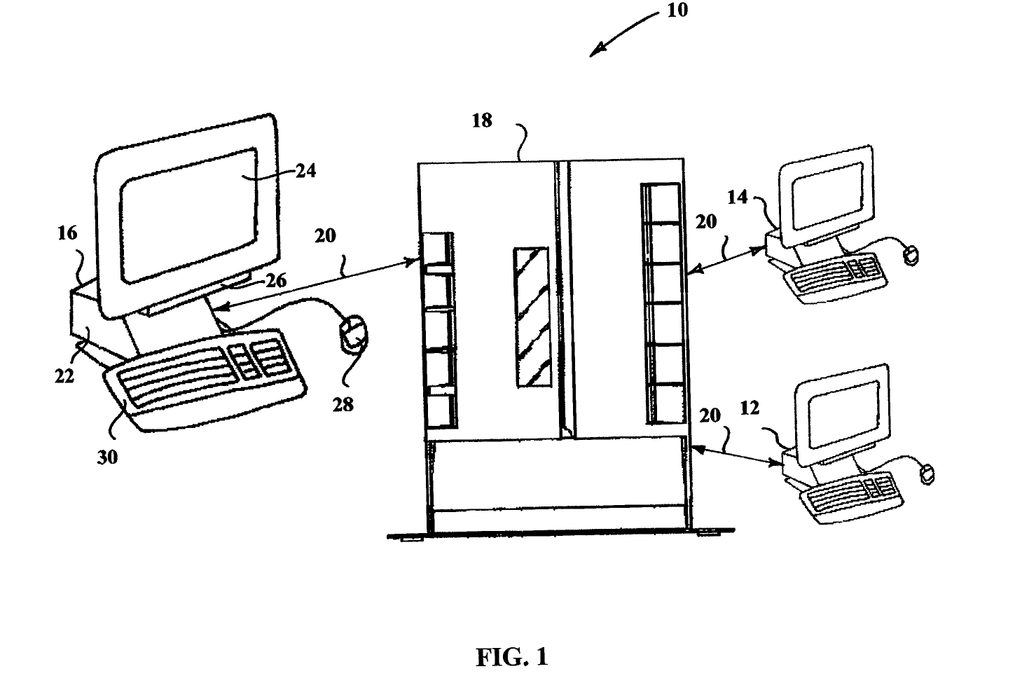

FIG. 1 illustrates a computer system 10 that is consistent with the invention. Computer system 10 is illustrated as a networked computer system. Computer system 10 includes one or more client computers 12, 14 and 16 (e.g., desktop or PC-based computers, workstations, etc.) coupled to server computer 18 (e.g., a PC-based server, a minicomputer, a midrange computer, a mainframe computer, etc.) through a network 20. The server computer 18 may comprise a plurality of enclosures as an alternative to the single enclosure illustrated in FIG. 1. Network 20 may represent practically any type of networked interconnection. For example, network 20 may be a local-area network (LAN), a wide-area network (WAN), a wireless network, and a public network (e.g., the Internet). Moreover, any number of computers and other devices may be networked through the network 20, e.g., multiple servers. In one application of the present invention, network 20 or a portion thereof may include a duplex cable connector mechanism according to the present invention. For example, a duplex cable connector assembly of the present invention may be plugged into a receptacle (not shown in FIG. 1) of one or more client computers 12, 14, 16 and/or server computer 18 to form the network 20 or a portion thereof.

Client computer 16, which may be similar to client computers 12 and 14, may include a central processing unit (CPU) 22; a number of peripheral components such as a computer display 24; a storage device 26; and various input devices (e.g., a mouse 28 and a keyboard 30), among others. Server computer 18 may be similarly configured, albeit typically with greater processing performance and storage capacity, as is well known in the art. In another application of the present invention, the interconnection (or a portion thereof) between input/output devices (e.g., disk drives, tape drives and printers) and client computer 16 and/or server computer 18 may include a duplex cable connector mechanism according to the present invention. For example, a duplex cable connector assembly of the present invention may be plugged into a receptacle (not shown in FIG. 1) of input/output devices and/or client computer 16 and/or server computer 18 to form the interconnection or a portion thereof. In yet another application of the present invention, a duplex cable connector mechanism according to the present invention may be utilized to interconnect various other electronic components of client computer 16 and/or server computer 18, e.g., the duplex cable connector assembly of the present invention may form a portion of an interconnection between electronic components of server computer 18 within a single enclosure and/or between a plurality of enclosures.

Although shown and described above in the environment of a computer, the present invention is not limited thereto. In general, the duplex cable connector mechanism of the present invention may be used to interconnect any electrical devices or components that utilize a duplex cable interconnection.

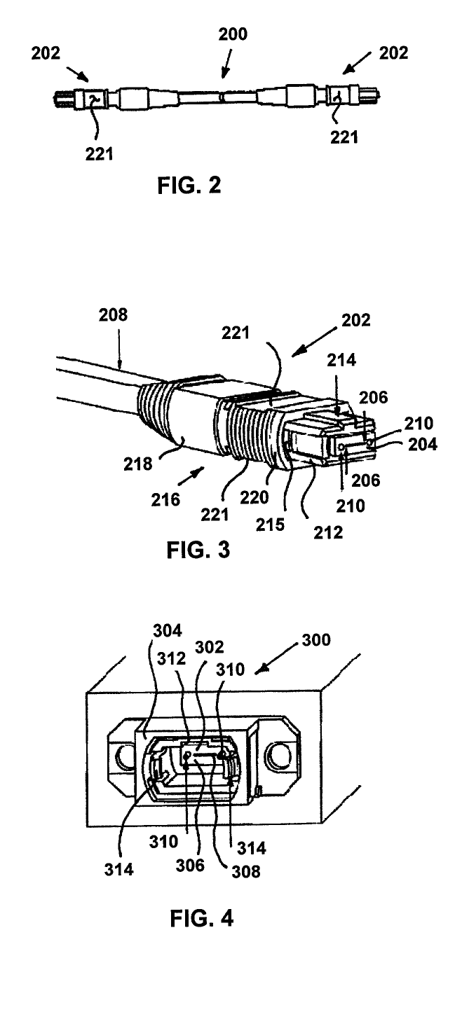

FIG. 2 is a top view of an exemplary fiber optic cable 200 having exemplary type MPO connectors 202 consistent with the present invention. Such connectors, sometimes referred to as MTP connectors, are specified in ISO/IEC 1754-7, Fibre Optic Connector Interfaces—Type MPO Connector Family. It should be appreciated, however, that the present invention is not limited to use in conjunction with fiber optic cables or type MPO connectors. The present invention may, for example, be used in conjunction with electronic cables and/or other types of connectors, which may be optical and/or electronic. Although the present invention is used in conjunction with a plurality of cables, only a single cable is shown in FIG. 2 for purposes of clarity. As shown in FIG. 2, each end of cable 200 includes an identical connector 202. It should be appreciated, however, that the ends of cable 200 may include non-identical connectors.

FIG. 3 is a perspective enlarged view of one of the type MPO connectors 202 of the cable 200 shown in FIG. 2. Connector 202 has a rectangular ferrule 204 preferably housing a plurality of side-by-side optical fibers 206, e.g., twelve, projecting out of the end of an optical fiber ribbon 208. In addition, ferrule 204 has a pair of alignment pin insertion holes 210, with the side-by-side optical fibers 206 located therebetween. As is conventional, ferrule 204 floats in the direction of the optical axis within a front housing 212 of connector 202, and is spring loaded in the direction of the optical axis toward another ferrule (discussed below) provided in a receptacle to which ferrule 204 is to be mated. As is also conventional, a top surface of the front housing 212 includes a key 214 and the two side surfaces of front housing 212 each include an ear member 215 (only one shown in FIG. 3). As is also conventional, connector 202 includes a push-pull coupling mechanism 216 that includes a push member 218 and a pull member 220. Pull member 220 includes a recess 221 on the top and bottom surfaces thereof.

FIG. 4 is a perspective view of an exemplary receptacle 300 into which the type MPO connector shown in FIG. 3 may be plugged. Typically, receptacle 300 includes a male plug 302 and an adapter 304. Such male plugs are specified in ISO/IEC 1754-7-5, MPO Male Plug Connector Flat Interface—Push/Pull, while such adapters are specified in ISO/IEC 1754-7-3, MPO Adapter Interface—Push/Pull. As noted above, however, it should be appreciated that the present invention is not limited to use in conjunction with fiber optic cables or type MPO connectors. The present invention may, for example, be used in conjunction with electronic cables and/or other types of connectors, which may be optical and/or electronic. Although the present invention is used in conjunction with a plurality of cables, and thus in conjunction with a plurality of receptacles or a plural receptacle (e.g., a double-receptacle), only one single-receptacle is shown in FIG. 4 for purposes of clarity.

Male plug 302 of receptacle 300 has a rectangular ferrule 306 housing a number of side-by-side optical fibers 308 that are positioned to correspond to the side-by-side optical fibers 206 provided in ferrule 204 of connector 202. Typically, side-by-side optical fibers 308 are each associated with an optical receiver and/or transmitter (not shown). Side-by-side optical fibers 308 provided in ferrule 306 of receptacle 300 are located between a pair of alignment pins 310 that are positioned for insertion into alignment pin insertion holes 210 in ferrule 204 of connector 202. As is conventional, adapter 304 of receptacle 300 includes a key groove 312 for receiving key 214 of the front housing 212 of connector 202. As is also conventional, adapter 304 of receptacle 300 includes a pair of resilient hook members 314 that engage ear members 215 of the front housing 212 of connector 202, and thereby latch connector 202 within receptacle 300.

In plugging connector 202 into receptacle 300, the front housing 212 of connector 202 is pushed into receptacle 300 using push member 218. The alignment pins 310 projecting from ferrule 306 of receptacle 300 are inserted into alignment pin insertion holes 210 in ferrule 204 of connector 202, and thereby align side-by-side optical fibers 206 provided in ferrule 203 of connector 202 with side-by-side optical fibers 308 provided in ferrule 306 of receptacle 300. In addition, hook members 314 provided on adapter 304 of receptacle 300 are engaged with ear members 215 provided on the side surfaces of the front housing 212 of connector 202, and thereby latch connector 202 within receptacle 300. Typically, hook members 314 resiliently deform as they ride up a ramped first surface of ear members 215 and then engage a ramped second surface of ear members 215 as they respectively enter a groove behind each ear member 215. Engagement of hook members 314 with the ramped second surfaces of ear members 215 latches connector 202 within receptacle 300.

In detaching connector 202 from receptacle 300, the front housing 212 of connector 202 is withdrawn from receptacle 300 using pull member 220. Pulling the pull member 220 in a direction away from receptacle 300 releases engagement of hook members 314 provided on adapter 304 of receptacle 300 from ear members 215 provided on the side surfaces of the front housing 212 of connector 202, and thereby unlatches connector 202 from receptacle 300. Typically, hook members 314 resiliently deform as they ride up the ramped second surfaces of ear members 215 and then ride down the ramped first surfaces of the ear members 215.

### Duplex Cable Connector Mechanism

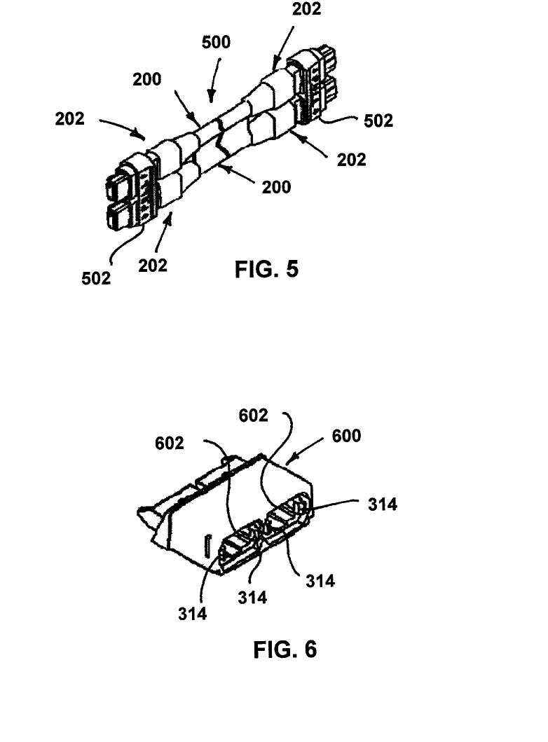

FIG. 5 is a perspective view of a duplex cable connector assembly 500 according to an embodiment of the present invention. Duplex cable connector assembly 500 includes two cables 200, each having a connector 202 at each end thereof. Each cable 200 is identical to that shown in FIG. 2, and each connector 202 is identical to that shown in FIG. 3. A duplex cable connector collar 502 joins the two connectors 202 at each end of each cable pair. It should be appreciated that the present invention is not limited to being used in conjunction with two cables, but may be used in conjunction with two, three or more cables. Therefore, “duplex” as the term is used herein refers to at least two.

Because connectors 202 are joined by collar 502, the probability of mis-configuration is reduced. Moreover this advantage is achieved without the introduction of another type of cable. That is, the same cable 200 may be used as a single cable or as part of a duplex cable.

FIG. 6 is a perspective view of a receptacle 600 for receiving the duplex cable connector assembly 500 shown in FIG. 5. Receptacle 600 is a double-receptacle, i.e., a common housing that incorporates in a single molded piece two receptacles substantially identical to receptacle 300 shown in FIG. 4. Alternatively, two separate receptacles may be used in lieu of the double-receptacle 600 shown in FIG. 6.

Referring back to FIG. 5, collar 502 is slid over the ends of connectors 202 and onto pull members 220 (shown in FIG. 3) to join connectors 202. As discussed in more detail below, collar 502 is retained on pull members 220. Accordingly, connectors 202 may be simultaneously detached from receptacle 600 by pulling collar 502 in a direction away from receptacle 600.

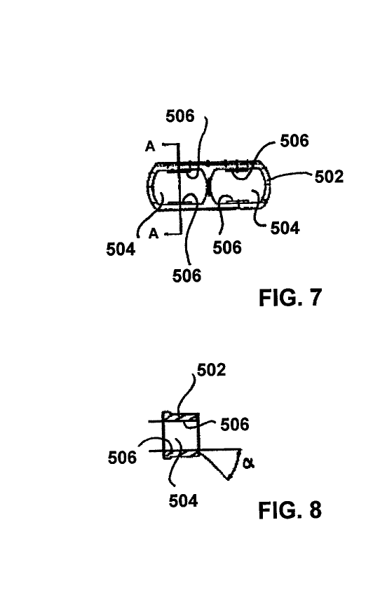

Collar 502 is shown removed from cables 200 in FIGS. 7 and 8. FIG. 7 shows an elevational view of collar 502, while FIG. 8 shows a cross-sectional view of collar 502 along cross-section A-A in FIG. 7. Collar 502 has two apertures 504, each configured to receive one pull member 220 (shown in FIG. 3). Apertures 504 of collar 502 space connectors 202 of cables 200 so that they register with insertion ports 602 (shown in FIG. 6) of receptacle 600. Connectors 202 each have a pull member 220 (shown in FIG. 3) operative to release engagement of an ear member 215 (shown in FIG. 3) of connector 202 with a hook member 314 (shown in FIG. 6) of the receptacle 600 to permit detachment of connector 202 from receptacle 600.

Apertures 504 of collar 502 each have a top and bottom projection 506 positioned to be received in a recess 221 (shown in FIG. 3) on pull members 220. Preferably, collar 502 is resilient to allow resilient deformation as projections 506 slide toward capture in recesses 221 on pull members 220. For example, collar 502 may be at least partially formed of a resilient material such as a polyurethane, rubber, or the like. Collar 502 may, for example, be molded from Texin 990 thermoplastic polyurethane available from Bayer Corporation. Preferably, the leading and trailing edges of projections 506 include a taper a to permit collar 502 to be more easily slid on and off pull members 220.

As discussed above, connectors 202 may be simultaneously detached from receptacle 600 by pulling collar 502 in a direction away from receptacle 600. Because projections 506 of collar 502 are captured in recesses 221 of connectors 202, collar 502 is more effective in retaining connectors 202 and reducing the probability of mis-configuration as compared to prior art clips. As discussed above, prior art clips tend to allow the cables to fall back through the channels or slots that permit insertion of the cables into the clips.

While this invention has been described with respect to the preferred and alternative embodiments, it will be understood by those skilled in the art that various changes in detail may be made therein without departing from the spirit, scope, and teaching of the invention. Accordingly, the herein disclosed invention is to be limited only as specified in the following claims.

What is claimed is:

1. A duplex cable connector assembly, comprising:
a first cable having a first connector configured to plug into a receptacle, the first connector having a first pull member operative to release engagement of an ear member of the first connector with a hook member of the receptacle to permit detachment of the first connector from the receptacle, the first pull member having a recess on a surface thereof;
a second cable having a second connector configured to plug into a receptacle, the second connector having a second pull member operative to release engagement of an ear member of the second connector with a hook member of the receptacle to permit detachment of the second connector from the receptacle, the second pull member having a recess on a surface thereof;
a collar having first and second apertures configured to respectively receive the first and second pull members, the first and second apertures each having a projection positioned to be received in the recess of the first and second pull members, respectively.

2. The assembly as recited in claim 1, wherein at least one of the first cable and the second cable is an optical cable.

3. The assembly as recited in claim 2, wherein the first and second connectors are selected from the type MPO connector family.

4. The assembly as recited in claim 1, wherein the collar includes a resilient material.

5. The assembly as recited in claim 4, wherein the resilient material is a polyurethane.

6. A duplex cable connector collar apparatus for joining a first connector of a first cable and a second connector of a second cable, wherein the first and second connectors are configured to plug into a receptacle, the first connector having a first pull member operative to release engagement of an ear member of the first connector with a hook member of the receptacle to permit detachment of the first connector from the receptacle, the second connector having a second pull member operative to release engagement of an ear member of the second connector with a hook member of the receptacle to permit detachment of the second connector from the receptacle, the first and second pull members each having a recess on a surface thereof, the apparatus comprising:
a collar having first and second apertures configured to respectively receive the first and second pull members, the first and second apertures each having a projection positioned to be received in the recess of the first and second pull members, respectively.

7. The apparatus as recited in claim 6, wherein at least one of the first cable and the second cable is an optical cable.

8. The apparatus as recited in claim 7, wherein the first and second connectors are selected from the type MPO connector family.

9. The apparatus as recited in claim 6, wherein the collar includes a resilient material.

10. The assembly as recited in claim 9, wherein the resilient material is a polyurethane.

11. A method of making a duplex cable connector assembly, comprising the steps of:
providing a first cable having a first connector configured to plug into a receptacle, the first connector having a first pull member operative to release engagement of an ear member of the first connector with a hook member of the receptacle to permit detachment of the first connector from the receptacle, the first pull member having a recess on a surface thereof;
providing a second cable having a second connector configured to plug into a receptacle, the second connector having a second pull member operative to release engagement of an ear member of the second connector with a hook member of the receptacle to permit detachment of the second connector from the receptacle, the second pull member having a recess on a surface thereof;
sliding a collar over the first and second connectors, the collar having first and second apertures configured to respectively receive the first and second pull members, the first and second apertures each having a projection positioned to be received in the recess of the first and second pull members, respectively.

12. The method as recited in claim 11, wherein the step of sliding comprises the step of resiliently deforming the collar as the projections of the first and second apertures of the collar move toward capture in the recesses of the first and second pull members.

13. A method of simultaneously detaching a first connector of a first cable and a second connector of a second cable from a receptacle, the first connector having a first pull member operative to release engagement of an ear member of the first connector with a hook member of the receptacle to permit detachment of the first connector from the receptacle, the second connector having a second pull member operative to release engagement of an ear member of the second connector with a hook member of the receptacle to permit detachment of the second connector from the receptacle, the first and second pull members each having a recess on a surface thereof, the method comprising the step of:
pulling a collar in a direction away from the receptacle, the collar having first and second apertures configured to respectively receive the first and second pull members, the first and second apertures each having a projection positioned to be received in the recess of the first and second pull members, respectively.
